(19) United States
(12) Patent Application Publication
(10) Pub. No.: US 2024/0004465 A1
(43) Pub. Date: Jan. 4, 2024

(54) EYE GAZE TRACKING SYSTEM AND VIRTUAL IMAGE DISPLAY DEVICE

(71) Applicant: FUJIFILM Corporation, Tokyo (JP)

(72) Inventors: Naoyoshi YAMADA, Minamiashigara-shi (JP); Megumi SEKIGUCHI, Minamiashigara-shi (JP)

(73) Assignee: FUJIFILM Corporation, Tokyo (JP)

(21) Appl. No.: 18/467,125

(22) Filed: Sep. 14, 2023

Related U.S. Application Data
(63) Continuation of application No. PCT/JP2022/011404, filed on Mar. 14, 2022.

(30) Foreign Application Priority Data
Mar. 15, 2021 (JP) 2021-041275

(51) Int. Cl. G06F 3/01; G06T 15/00; H04N 23/11; G02B 5/08; G02B 5/30

(52) U.S. Cl. CPC G06F 3/013; G06T 15/00; G02B 5/30; G02B 5/08; H04N 23/11

(57) ABSTRACT

An object is to provide an eye gaze tracking system capable of easily detecting an eye gaze, and a virtual image display device using the same. The object is achieved by providing an infrared light source array, a virtual image generation optical system, and an infrared light detector, and by sequentially turning on infrared light sources of the infrared light source array, collimating rays of infrared light through the virtual image generation optical system, making the collimated rays of infrared light incident on a user's eye at different angles, respectively, and detecting, among the rays of infrared light incident on the eye, a ray of infrared light incident on a retina through a pupil and reflected by the retina through the infrared light detector.

### CROSS-REFERENCE TO RELATED APPLICATIONS

This application is a Continuation of PCT International Application No. PCT/JP2022/011404 filed on Mar. 14, 2022, which claims priority under 35 U.S.C. § 119(a) to Japanese Patent Application No. 2021-041275 filed on Mar. 15, 2021. The above applications are hereby expressly incorporated by reference, in their entirety, into the present application.

### BACKGROUND OF THE INVENTION

### 1. Field of the Invention

The present invention relates to an eye gaze tracking system used for a head-mounted display or the like, and a virtual image display device equipped with the eye gaze tracking system.

### 2. Description of the Related Art

As means for providing a user with a virtual reality (VR) and an augmented reality (AR), a head-mounted display (HMD), an AR glass, or the like has been put into practical use. It is desired for a VR system that provides the VR and an AR system that provides the AR to incorporate a function of detecting the user's eye gaze.

By detecting the user's eye gaze, it is possible to determine what the user is observing. Accordingly, various kinds of processing becomes possible, such as displaying in detail what the user is observing, emphasizing what the user is observing, focusing on what the user is observing, displaying what the user is observing in high resolution, and using the user's eye gaze as a pointing device.

As a result, functions of the HMD, the AR glass, and the like are improved, which makes it possible to realize the HMD, the AR glass, and the like with higher performance.

In eye gaze detection using the HMD, the AR glass, or the like, the user's eye is irradiated with non-visible light such as infrared light, reflected light thereof is imaged, and an obtained image is analyzed, whereby the user's eye gaze is detected.

For example, WO2016-157485A describes an HMD having a function of detecting a user's eye gaze, the HMD comprising: a convex lens disposed at a position facing the user's cornea in a case where the HMD is worn by the user; a plurality of infrared light sources that are disposed around the convex lens and that emit infrared light toward the user's cornea; a camera that captures a video including the user's cornea; and a housing that houses these, in which in a case where a periphery of the convex lens is divided into a first region, which is a region on an outer corner side of the user's eye, a second region, which is a region on an inner corner side of the eye, a third region, which is a region on a parietal side, and a fourth region, which is a region on a chin side, the infrared light sources are disposed in the first region or the second region.

### SUMMARY OF THE INVENTION

In the HMD described in WO2016-157485A, the convenience of the HMD is improved by detecting the user's eye gaze (eye gaze direction) and using this as a pointing device.

Here, in the eye gaze detection that has been conventionally incorporated into the HMD, the AR glass, or the like, including the eye gaze detection described in WO2016-157485A, the eye gaze is detected by irradiating the user's eye (eyeball) with non-visible light such as infrared light and analyzing a reflected image formed by light reflected at the eyeball.

For example, in the conventional eye gaze detection, the eye gaze is detected by irradiating the eyeball with infrared light and analyzing the reflected images of non-visible light reflected at a cornea anterior surface, crystalline lens anterior and posterior surfaces, and a cornea posterior surface. These reflected images are called Purkinje images.

However, the eye gaze detection using a Purkinje image or the like has a problem of complicated computational processing and a significant computational load.

The user's eye gaze such as an HMD moves at a very high speed. Therefore, in a case where a complicated computation is performed, there may be cases where the eye gaze detection cannot keep up with the movement of the eye gaze.

In a case where the eye gaze detection cannot keep up with the movement of the eye gaze, the above-described processing, such as emphasizing what the user is observing, the action as a pointing device, and the like cannot be performed properly.

An object of the present invention is to solve such a problem of the related art and to provide an eye gaze tracking system capable of easily detecting the user's eye gaze without performing complicated computation in an HMD, an AR glass, or the like, and a virtual image display device using the eye gaze tracking system.

In order to achieve the object, the present invention has the following configurations.

[1] An eye gaze tracking system comprising:
an infrared light source array;
a virtual image generation optical system; and
an infrared light detector,
in which infrared light sources of the infrared light source array are sequentially turned on, rays of infrared light are collimated by the virtual image generation optical system, the collimated rays of infrared light are made incident on a user's eye at different angles, respectively, and among the rays of infrared light incident on the eye, a ray of infrared light incident on a retina through a pupil and reflected by the retina is detected by the infrared light detector.

[2] A virtual image display device comprising:
the eye gaze tracking system according to [1]; and
an image display device,
in which the infrared light source array is incorporated into the image display device.

[3] A virtual image display device comprising:
the eye gaze tracking system according to [1]; and
an image display device,
in which the image display device includes a region through which infrared light is transmitted, and
the infrared light source array is disposed on a side opposite to a visual recognition side of the image display device.

[4] The virtual image display device according to [2] or [3],
in which the infrared light detector is incorporated into the image display device.

[5] The virtual image display device according to [2] or [3],
in which the image display device includes a region through which infrared light is transmitted, and
the infrared light detector is disposed on a side opposite to a visual recognition side of the image display device.

[6] The virtual image display device according to any one of [2] to [5],
in which the virtual image generation optical system includes at least one of a convex lens or a Fresnel lens.

[7] The virtual image display device according to any one of [2] to [5],
in which the virtual image generation optical system includes a folded optical system including a reflective polarizer and a half mirror.

[8] The virtual image display device according to any one of [2] to [5],
in which the virtual image generation optical system includes a light guide plate including a light incidence portion and a light emission portion.

[9] The virtual image display device according to [8],
in which at least one of the light incidence portion or the light emission portion includes a diffraction element.

[10] The virtual image display device according to [9],
in which the diffraction element is a liquid crystal diffraction element.

According to the present invention, it is possible to easily detect the user's eye gaze without performing a complicated computation in the HMD, AR glass, or the like.

### BRIEF DESCRIPTION OF THE DRAWINGS

FIG. 1 is a conceptual diagram illustrating an eye gaze tracking system of an embodiment of the present invention.

FIG. 2 is a diagram conceptually showing an example of the eye gaze tracking system of the embodiment of the present invention.

FIG. 3 is a diagram conceptually showing another example of the eye gaze tracking system of the embodiment of the present invention.

FIG. 4 is a diagram conceptually showing an example of a virtual image generation optical system.

FIG. 5 is a diagram conceptually showing another example of the virtual image generation optical system.

FIG. 6 is a diagram conceptually showing an example of a virtual image display device of the embodiment of the present invention.

FIG. 7 is a diagram conceptually showing another example of the virtual image display device of the embodiment of the present invention.

FIG. 8 is a diagram conceptually showing still another example of the virtual image display device of the embodiment of the present invention.

FIG. 9 is a diagram conceptually showing still another example of the virtual image display device of the embodiment of the present invention.

### DESCRIPTION OF THE PREFERRED EMBODIMENTS

Hereinafter, an eye gaze tracking system and a virtual image display device of the embodiment of the present invention will be described in detail based on suitable examples shown in the drawings.

In the present specification, a numerical range represented by “to” means a range including numerical values described before and after “to” as a lower limit value and an upper limit value, respectively.

In the present invention, visible light refers to light having a wavelength of 380 nm or more and less than 700 nm. In addition, infrared light refers to light having a wavelength of 700 nm to 1 mm.

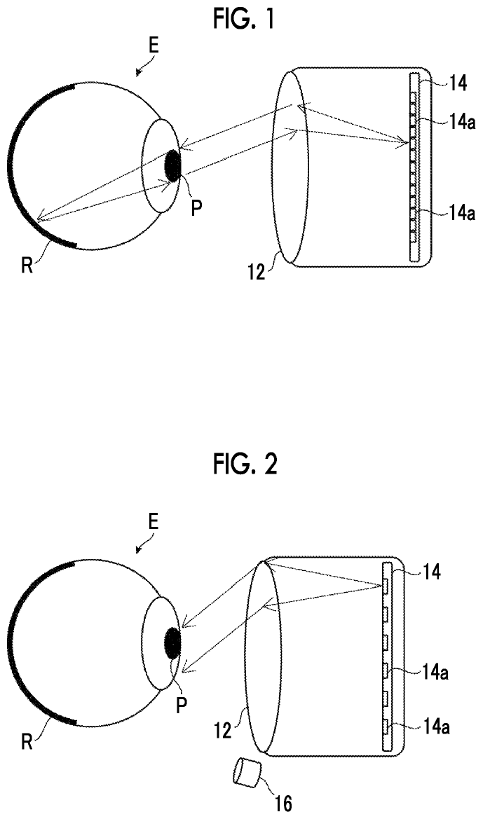

First, a basic concept of the eye gaze tracking system of the embodiment of the present invention will be described with reference to FIG. 1.

In eye gaze detection in the conventional VR system and AR system such as an HMD and an AR glass, a user's eye gaze is detected by irradiating an eyeball with non-visible light such as infrared light and performing computational processing on, for example, a reflected image called a Purkinje image.

However, as described above, the conventional eye gaze detection, such as the eye gaze detection using a Purkinje image or the like, requires complicated computation and imposes a significant computational load.

On the other hand, in the eye gaze tracking system of the embodiment of the present invention, as conceptually shown in FIG. 1 using a VR system as an example, the user's eye gaze is detected by irradiating the user's eye E (eyeball) with collimated infrared light and detecting the infrared light which passes through a pupil P and which is reflected by a retina R.

In a case where the eye E is irradiated with collimated infrared light, most of the infrared light is normally reflected at or near a surface of the eye E, such as the cornea and the crystalline lens, and only a small amount of the infrared light passes through the pupil P and reaches the retina R.

On the other hand, as will be described in detail later, in a case where the eye gaze is directed toward an incidence direction of the collimated infrared light, as shown in FIG. 1, the infrared light penetrates the inside of the eye E through the pupil P and reaches the retina R, and then is retroreflected by the retina R and is emitted through the pupil P.

That is, in a case where collimated infrared light is incident on the eye E from various directions and the infrared light retroreflected by the retina R can be detected, it is considered that the eye gaze is directed toward the incidence direction of the collimated light.

The eye gaze tracking system of the embodiment of the present invention uses this.

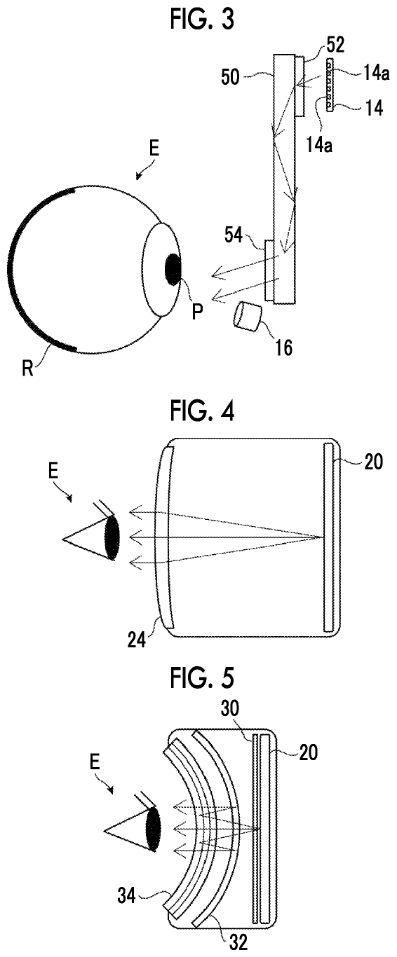

FIG. 2 conceptually shows an example of a case where the eye gaze tracking system of the embodiment of the present invention is used in the VR system such as an HMD. In addition, FIG. 3 conceptually shows an example of a case where the eye gaze tracking system of the embodiment of the present invention is used in the AR system such as an AR glass. Normally, the VR system has an image display device for displaying the virtual reality, and the AR system has an image display device for displaying the augmented reality.

In the eye gaze tracking system of the embodiment of the present invention, an infrared light source array 14 in which infrared light sources 14a are arranged one-dimensionally, preferably two-dimensionally, is used to sequentially turn on the infrared light sources 14a, and infrared light that is incident on the eye E (eye, eyeball) by being collimated by a virtual image generation optical system 12 and that is retroreflected by the retina R is detected by an infrared light detector 16, thereby detecting and tracking the eye gaze.

That is, as described above, normally, even in a case where collimated infrared light is incident on the eye E, the infrared light is mostly reflected at or near the surface of the eye E and does not reach the retina R.

However, in a case where the user's eye gaze is directed toward a direction of the turned-on infrared light source 14a of the infrared light source array 14, as shown in FIG. 1 described above, the collimated infrared light passes through the pupil P and penetrates the inside of the eye E, and then is retroreflected by the retina R and is emitted through the pupil P.

Therefore, in a case where the infrared light reflected by the retina R can be detected by the infrared light detector 16, it is possible to detect that the user's eye gaze is directed toward the incidence direction of the infrared light from the infrared light source 14a turned on at that time.

As a result, with the eye gaze tracking system of the embodiment of the present invention, the user's eye gaze can be easily detected without performing complicated computation in the VR system, the AR system, or the like.

Specifically, in the example corresponding to the VR system shown in FIG. 2, each infrared light source 14a of the infrared light source array 14 is sequentially turned on.

In a case where the infrared light source 14a is turned on, the infrared light is collimated by the virtual image generation optical system 12 and is incident on the eye E, similarly to the image of the image display device in the VR system, that is, the image of the virtual reality.

Here, in a case where the user's eye gaze is not directed toward the incidence direction of the infrared light from the turned-on infrared light source 14a, as described above, the infrared light is mostly reflected at the surface (near the surface) of the eye E and does not reach the retina R even in a case where the collimated infrared light is incident on the eye E. Therefore, in this case, the reflected light from the retina R is not measured by the infrared light detector 16.

On the other hand, in a case where the user's eye gaze is directed toward the incidence direction of the infrared light from the infrared light source 14a, as shown in FIG. 1 described above, the collimated infrared light passes through the pupil P and is retroreflected by the retina R, and then is emitted through the pupil P, so that the infrared light can be detected by the infrared light detector 16. Therefore, the incidence direction of the infrared light from the infrared light source 14a that is turned on at that time in point can be detected as the user's eye gaze.

Meanwhile, an example corresponding to the AR system shown in FIG. 3 includes the infrared light source array 14, and a light guide plate 50, a light incidence portion 52, and a light emission portion 54 that act as the virtual image generation optical system.

Similarly, in the case of the AR system, the infrared light sources 14a of the infrared light source array 14 are sequentially turned on.

In a case where the infrared light source 14a is turned on, the infrared light is refracted by the light incidence portion 52 and is incident on the light guide plate 50 at an angle at which the infrared light is totally refracted and is propagated, similarly to the image of the image display device in the AR system, that is, the image of the augmented reality. The infrared light incident on the light guide plate 50 is propagated in the light guide plate 50 while repeating total reflection and is incident on the light emission portion 54. In addition, the infrared light is collimated by the action of the light guide plate 50 and of the light incidence portion 52 that are the virtual image generation optical system. The light incidence portion 52 may have a lens or the like for collimating light, as necessary. The infrared light incident on the light emission portion 54 is refracted by the light emission portion 54, and is emitted from the light guide plate 50 and is incident on the eye E.

Here, in a case where the user's eye gaze is not directed toward the incidence direction of the infrared light from the turned-on infrared light source 14a, as described above, the infrared light is mostly reflected at the surface (near the surface) of the eye E and does not reach the retina R even in a case where the collimated infrared light is incident on the eye E. Therefore, in this case, the reflected light from the retina R is not measured by the infrared light detector 16.

On the other hand, in a case where the user's eye gaze is directed toward the incidence direction of the infrared light from the infrared light source 14a, as shown in FIG. 1 described above, the collimated infrared light passes through the pupil P and is retroreflected by the retina R, and then is emitted through the pupil P, so that the infrared light can be detected by the infrared light detector 16. Therefore, the incidence direction of the infrared light from the infrared light source 14a that is turned on at that time in point can be detected as the user's eye gaze.

As described above, in the eye gaze tracking system of the embodiment of the present invention, the user's eye gaze is detected by irradiating the user's eye E with the collimated infrared light, making the infrared light incident through the pupil P, and detecting the light retroreflected at the retina R.

As a method of detecting (imaging) the infrared light reflected at the retina R, a bright pupil method is known as an example.

The bright pupil method is a method of detecting reflected light from the retina R by making collimated light, that is, light with high parallelism, incident on the eye E.

In a case where a center line (a straight line passing through the center of the pupil P and perpendicular to a corneal surface) of the pupil P of the eye E and an optical axis connecting the light source and the center of the pupil P is aligned with or close to each other when the collimated light is incident on the eye E, the light incident through the pupil P is reflected at the retina R and is retroreflected along the above-described optical axis by passing through the pupil P again. Therefore, in this case, the reflected light is emitted through the pupil P with a relatively high intensity, and the pupil P is detected as brighter than a peripheral area. In a case where incidence light is visible light, the reflected light appears red due to blood flowing through the capillaries of the retina. This is a phenomenon known as a so-called red-eye effect.

On the other hand, in a case where the center line of the pupil P is not aligned with the optical axis connecting the light source and the center of the pupil P, as described above, the light incident through the pupil P does not reach the retina R, or does not reach the pupil P again and is not retroreflected even in a case where the light reaches the retina R and is reflected. Therefore, the pupil P area becomes dark. Since an iris present in the periphery of the pupil P is colored, the reflected light from the peripheral area of the pupil P has a higher intensity than the reflected light from the pupil P area, and the pupil P area is detected as darker than the peripheral area.

In this way, it is possible to determine that the reflected light from the retina R is detected in a case where the pupil P is imaged brighter than the peripheral area by using the bright pupil method. In addition, in this case, it can be seen that the center line of the pupil P and the optical axis connecting the light source and the center of the pupil P are aligned or at close angles. Since the center line of the pupil P is substantially aligned with the user's eye gaze vector, it is possible to decide on the direction of the user's eye gaze. That is, as described above, the incidence direction of the infrared light from the infrared light source 14a to the eye E can be detected as the direction of the user's eye gaze according to the position of the infrared light source 14a in the infrared light source array 14.

It is also possible to further improve the detection accuracy of the direction of the eye gaze by measuring the deviation between the center line of the pupil P and the eye gaze vector of the user in advance and correcting the difference using this data.

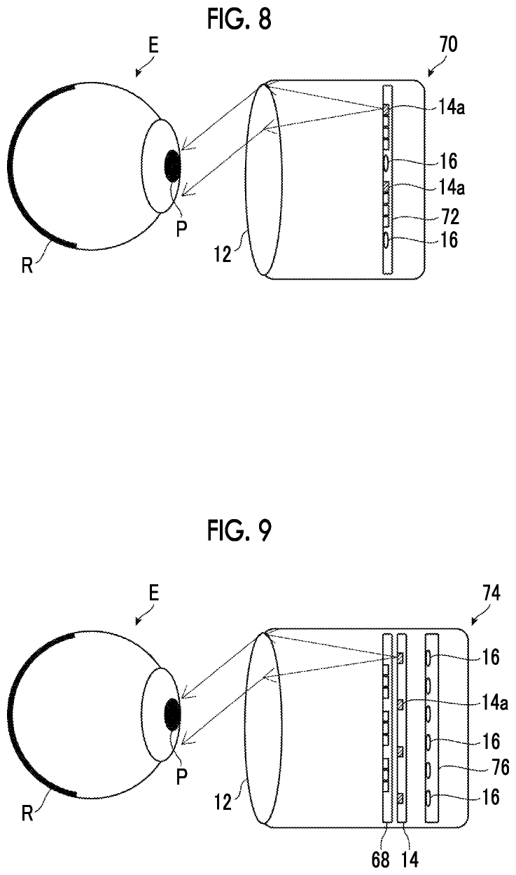

This bright pupil method is suitably used in a case where optical axes of the infrared light source 14a and of the infrared light detector 16 are aligned with or close to each other, as shown in FIGS. 8 and 9, which will be described later. That is, the bright pupil method is suitably used in a case where an optical path of light emitted by the infrared light source 14a and retroreflected from the retina R, and the infrared light detector 16 are located close to each other.

In the present invention, the infrared light reflected by the retina R may be detected (imaged) using two or more types of rays of infrared light having different wavelengths.

This method is a method of identifying the reflected light from the retina R and the reflected light from an area other than the retina R by using the fact that the intensity of light reflection by the retina R varies depending on the wavelength.

For example, in a case where infrared light A having a wavelength of 800 nm and infrared light B having a wavelength of 1000 nm are used, the infrared light A easily reaches the retina R and is detected as retroreflected light. On the other hand, since the infrared light B has a smaller amount of light reaching the retina R due to absorption in the eye E, the intensity of reflection from the retina R is also reduced.

Therefore, in a case where the detection intensity of the infrared light A is larger than the detection intensity of the infrared light B, it can be determined that the infrared light A is the reflected light from the retina R. On the other hand, in a case where the difference in the detection intensity between the infrared light A and the infrared light B is small, it can be inferred that the rays of light are rays of light reflected by the surface of the corneal surface, the surface of the eye E, or the like, rather than the reflected light from the retina.

Therefore, in a case where the detection intensity of the infrared light A is larger than the detection intensity of the infrared light B, the incidence direction of the infrared light to the eye E from the infrared light source 14a, which has emitted the infrared light A in the infrared light source array 14, can be detected as the direction of the user's eye gaze according to the position of this infrared light source 14a.

This method using rays of infrared light having a plurality of wavelengths is suitably used in a case where the optical axes of the infrared light source 14a and of the infrared light detector 16 are not aligned with or close to each other as shown in FIGS. 2, 3, 6, and 7. That is, this method using rays of infrared light having a plurality of wavelengths is suitably used in a case where the optical path of light emitted by the infrared light source 14a and retroreflected from the retina R, and the infrared light detector 16 are located far from each other.

In the present example, in this case, it is preferable that the infrared light sources 14a that emit rays of infrared light having different wavelengths are provided close to each other.

In the eye gaze tracking system of the embodiment of the present invention, the infrared light detector 16 is not limited, and various types of light detectors capable of detecting infrared light can be used.

Therefore, the infrared light detector 16 may be a light detection element that consists of a single pixel and does not have a function of capturing an image. In this case, it is preferable that the optical axis connecting the infrared light source 14a and the center of the pupil P and the optical axis connecting the infrared light detector 16 and the center of the pupil P are aligned with or close to each other. That is, it is preferable that the optical axes of the infrared light source 14a and of the infrared light detector 16 are aligned with or close to each other.

In a case where the optical axes of the infrared light source 14a and of the infrared light detector 16 are disposed so as to be aligned with each other, the infrared light retroreflected by the retina R is detected with high intensity. Therefore, in this disposition, it is possible to identify whether the reflected light is the retroreflected light from the retina R or the reflected light from the peripheral area based on the detection intensity of the reflected light. That is, the infrared light detector 16 consisting of a single pixel is suitably used in a case where the eye gaze detection is performed by using the bright pupil method described above.

In addition, the infrared light detector 16 may be an imaging device capable of capturing an image of the eye E (the user's eye).

In this case, the reflected light from the retina R and the reflected light from an area other than the retina R can be identified by using the captured images to identify the pupil P area and the peripheral area and to compare the respective brightness.

Therefore, it is possible to use the imaging device as the infrared light detector 16 to identify the reflected light by the retina R and the reflected light from other areas even in a case where the optical axes of the infrared light source 14a and of the infrared light detector 16 are not aligned with each other. That is, in an aspect in which the imaging device is used as the infrared light detector 16, it is possible to perform the eye gaze detection using the bright pupil method by determining whether the pupil P area is brighter or darker than the peripheral area based on the images. In addition, in a case where the infrared light detector 16 has pixels for detecting rays of infrared light having different wavelengths, such as the infrared light A and the infrared light B described above, it is possible to perform the eye gaze detection through the above-described method using two or more types of rays of infrared light having different wavelengths by comparing the intensity of the infrared light A and the intensity of the infrared light B in the reflected light from the pupil P area.

The eye gaze tracking system of the embodiment of the present invention uses infrared light as the detection light for the eye gaze detection.

The wavelength of the infrared light is not limited and need only be any infrared light in the wavelength range described above.

Here, in order to restrain the detection light for the eye gaze detection from being visually recognized by the user and to increase the reflectivity at the retina R, the wavelength of the infrared light is preferably 700 nm or more and more preferably 800 nm or more. In addition, in order to increase the transmittance in the eye E, the wavelength of the infrared light is preferably 1000 nm or less and more preferably 900 nm or less.

In the eye gaze tracking system of the embodiment of the present invention, infrared light collimated by the virtual image generation optical system 12 is incident on the eye E.

The eye gaze tracking system of the embodiment of the present invention is basically used for the VR system such as an HMD and the AR system such as an AR glass. The VR system displays virtual reality through the image display device and allows the user to observe it. Meanwhile, the AR system displays augmented reality through the image display device and allows the user to observe it.

Here, in order to allow a proper image to be observed, it is necessary for both the VR system and the AR system to present the display image to be displayed by the image display device in a way that it appears to be located several meters ahead, even though it is actually located a few centimeters away from the user's eye. In response to this, the VR system and the AR system are designed such that the user can see the virtual image several meters ahead by using the virtual image generation optical system. Therefore, in the virtual image generation optical systems of the VR system and of the AR system, the display image to be displayed by the image display device is collimated at a position where the display image is incident on the user's eye, and is rendered in a state close to parallel light.

In other words, the VR system and the AR system collimate the display image, which is to be displayed by the image display device and is located a few centimeters in front of the user's eye, that is, the irradiation light, through the virtual image generation optical system, thereby generating the virtual image that appears distant to the user. That is, the VR system and the AR system are inherently provided with a function of collimating the light that has come out of the image display device located a few centimeters in front of the user's eye through the virtual image generation optical system and of presenting the image as if the image is located at a distance.

The present invention uses this.

That is, in the eye gaze tracking system of the embodiment of the present invention, the infrared light emitted by each infrared light source 14a of the infrared light source array 14 is collimated by using the virtual image generation optical system 12 provided in the VR system and the AR system, and is incident on the user's eye E.

The virtual image generation optical system 12 is not limited, and various types of known virtual image generation optical systems used in the VR system and the AR system can be used.

Examples of the virtual image generation optical system used in the VR system include, as conceptually shown in FIG. 4, a virtual image generation optical system using a Fresnel lens 24 that collimates the display image (irradiation light) to be displayed by an image display device 20. In this virtual image generation optical system, instead of the Fresnel lens 24, a convex lens that collimates the display image to be displayed by the image display device 20 may be used.

As the virtual image generation optical system used in the VR system, a so-called pancake lens including a folded optical system, which includes a half mirror and a reflective polarizer, is also suitably used. FIG. 5 conceptually shows an example of this virtual image generation optical system.

The virtual image generation optical system shown in FIG. 5 includes a quarter-wave plate 30, a half mirror 32, and a reflective polarizer 34 from an image display device 20 side. The reflective polarizer 34 is a reflective type circular polarizer that reflects light that is circularly polarized in one turning direction and that transmits light that is circularly polarized in the opposite turning direction.

The pancake lens is not limited to the configuration shown in FIG. 5, and various pancake lenses used as the virtual image generation optical system in the VR system can be used.

In the virtual image generation optical system (pancake lens) shown in FIG. 5, as an example, the image display device 20 emits linearly polarized light as in an organic electroluminescence display including an antireflection film and a liquid crystal display device. In a case where the image display device 20 emits unpolarized light, a linear polarizer may be provided between the quarter-wave plate 30 and the image display device 20.

The image of the linearly polarized light displayed by the image display device 20 is converted to circularly polarized light in the turning direction, which is to be reflected by the reflective polarizer 34, by the quarter-wave plate 30. In the present example, as an example, the quarter-wave plate 30 converts the image of the linearly polarized light displayed by the image display device 20 into dextrorotatory circularly polarized light to be reflected by the reflective polarizer 34.

Approximately half of the image of the dextrorotatory circularly polarized light is transmitted through the half mirror and is incident on the reflective polarizer 34. The reflective polarizer 34 selectively reflects the dextrorotatory circularly polarized light. Therefore, the image of the dextrorotatory circularly polarized light is reflected by the reflective polarizer 34 and is incident on the half mirror 32 again.

Approximately half of the image of the dextrorotatory circularly polarized light incident on the half mirror 32 is reflected by the half mirror 32. During this reflection, the image of the dextrorotatory circularly polarized light is converted into levorotatory circularly polarized light.

The image of the levorotatory circularly polarized light reflected by the half mirror 32 is then incident on the reflective polarizer 34. As described above, the reflective polarizer 34 selectively reflects the dextrorotatory circularly polarized light. Therefore, the image of the levorotatory circularly polarized light is transmitted through the reflective polarizer 34 and is observed by the user as a virtual reality.

In the pancake lens configured in this manner, the light is reciprocated between the half mirror 32 and the reflective polarizer 34 to increase the optical path length, which allows the user to observe the virtual image as if the virtual image is located at a distance.

Meanwhile, similarly to the infrared light emitted by the infrared light source 14a of the infrared light source array 14 described above, the AR system such as an AR glass allows the user to observe the image displayed by the image display device as the image of the augmented reality by using the light guide plate 50 including the light incidence portion 52 and the light emission portion 54.

That is, as described above, the image (emitted light) displayed by the image display device is refracted by the light incidence portion 52, is incident on the light guide plate 50, and is propagated in the light guide plate 50 while repeating total reflection. The image propagated in the light guide plate 50 is eventually incident on the light emission portion 54, is refracted by the light emission portion 54, is emitted from the light guide plate 50, and is observed as the augmented reality by the user.

In the AR system, light to be the virtual image is collimated by the action of the light guide plate 50 and of the light incidence portion 52 that form the virtual image generation optical system.

In the eye gaze tracking system and the virtual image display device of the embodiment of the present invention, the light incidence portion 52 and the light emission portion 54 used in the AR system are not limited, and various types of known elements used in the AR system can be used.

A diffraction element is preferably used for the light incidence portion 52 and the light emission portion 54. The diffraction element is not limited, and various types of known diffraction elements, such as a liquid crystal diffraction element, a volume hologram diffraction element, and a surface relief diffraction element, can be used.

In the example shown in FIG. 3, a transmissive type diffraction element is used in a case where the diffraction element is used for the light incidence portion 52 and the light emission portion 54, but the present invention is not limited thereto, and a reflective type diffraction element may be used to perform incidence and/or emission of light with respect to the light guide plate 50.

As the diffraction element, a liquid crystal diffraction element is suitably used.

The liquid crystal diffraction element is also not limited, and various types of known liquid crystal diffraction elements can be used.

Examples of the transmissive type liquid crystal diffraction element include a liquid crystal diffraction element described in WO2019/131918A including an optically anisotropic layer that is formed of a composition containing a liquid crystal compound and that has a liquid crystal alignment pattern in which a direction of the optical axis derived from the liquid crystal compound changes while continuously rotating along at least one direction in the plane.

In addition, examples of the reflective type liquid crystal diffraction element include a liquid crystal diffraction element described in WO2019/163944A including a cholesteric liquid crystal layer that has a liquid crystal alignment pattern in which a direction of the optical axis derived from a liquid crystal compound changes while continuously rotating along at least one direction in the plane.

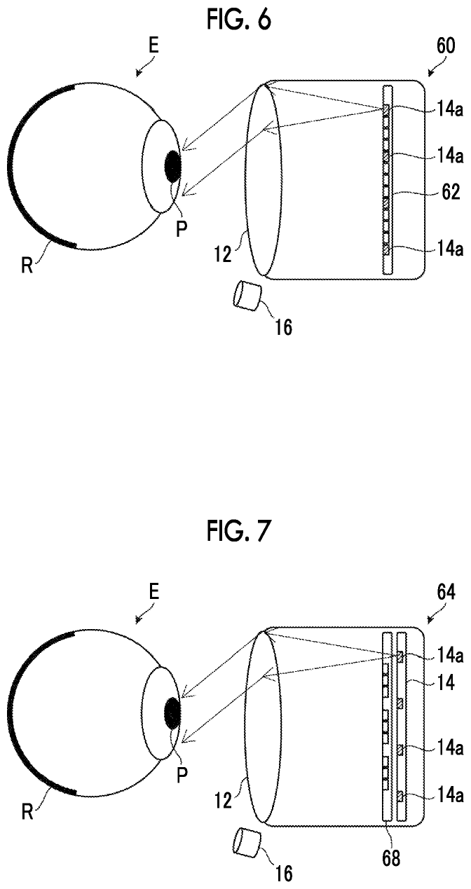

FIG. 6 conceptually shows an example of the virtual image display device of the embodiment of the present invention using the eye gaze tracking system of the embodiment of the present invention.

The following examples shown in FIGS. 6 to 9 are all examples in which the virtual image display device of the embodiment of the present invention is used in the VR system such as an HMD, but in the AR system such as an AR glass, it is also possible to utilize an AR system using the virtual image display device of the embodiment of the present invention by disposing the image display device and the infrared light detector 16 in the same manner in correspondence with the infrared light source array 14 shown in FIG. 3.

The virtual image display devices of the embodiment of the present invention each include the eye gaze tracking system of the embodiment of the present invention and include the image display device and the virtual image generation optical system 12.

As described above, in the eye gaze tracking system of the embodiment of the present invention, the virtual image generation optical system 12 provided in the VR system is used to collimate the infrared light emitted by the infrared light source of the infrared light source array. That is, the virtual image display device of the embodiment of the present invention is incorporated into the known VR system (AR system) with the above-described infrared light source array and infrared light detector.

In the virtual image display device of the embodiment of the present invention, the image display device is not limited, and various types of known image display devices used in the VR system (AR system) can be used.

Examples thereof include a liquid crystal display, an organic electroluminescence display, and a micro light emitting diode (LED) display.

A virtual image display device 60 shown in FIG. 6 uses an image display device 62 that incorporates the infrared light source array.

That is, the image display device 62 includes pixels serving as the infrared light sources 14a that emit infrared light in addition to pixels for performing image display in red, green, and blue, as indicated by outlined white boxes, whereby the image display device incorporates the infrared light source array.

In the virtual image display device 60, the infrared light sources 14a incorporated into the image display device 62 are sequentially turned on while the virtual reality is displayed by the image display device 62, and are collimated by the virtual image generation optical system 12, and the infrared light reflected at the retina R is detected by the infrared light detector 16, thereby detecting and tracking the user's eye gaze.

Meanwhile, a virtual image display device 64 shown in FIG. 7 uses an image display device 68 having a region through which infrared light can be transmitted.

The infrared light source array 14 in which the infrared light sources 14a are arranged is disposed on a side opposite to a visual recognition side (display surface) of the image display device 68. Therefore, in the image display device 68, a position corresponding to the infrared light source 14a in the infrared light source array 14 does not have a pixel for image display and corresponds to the region through which infrared light can be transmitted.

Also in the virtual image display device 64, the infrared light sources 14a of the infrared light source array 14 are sequentially turned on while the virtual reality is displayed by the image display device 68, and are collimated by the virtual image generation optical system 12, and the infrared light reflected at the retina R is detected by the infrared light detector 16, thereby detecting and tracking the user's eye gaze.

In the image display device 68, the region through which infrared light can be transmitted need only be provided using, for example, various known methods, such as a method of providing through-holes and a method of using a substrate capable of transmitting infrared light as a substrate of the image display device 68.

As described above, in the virtual image display device shown in FIGS. 6 and 7, it is preferable that the infrared light source array includes the infrared light sources 14a such that two or more types of rays of infrared light having different wavelengths are emitted. In this case, it is preferable that the infrared light sources 14a having different wavelengths are provided close to each other as described above.

A virtual image display device 70 shown in FIG. 8 uses an image display device 72 that incorporates the infrared light source array and the infrared light detector 16.

That is, the image display device 72 includes pixels serving as the infrared light sources 14a that emit infrared light in addition to pixels for performing image display in red, green, and blue, as indicated by outlined white boxes, whereby the image display device incorporates the infrared light source array.

Further, the image display device 72 incorporates the infrared light detector 16 indicated by an ellipse in correspondence with the infrared light source 14a. The infrared light detector 16 need only be incorporated into the image display device 72 by a known method.

In the virtual image display device 70, the infrared light sources 14a incorporated into the image display device 72 are sequentially turned on while the virtual reality is displayed by the image display device 72, and are collimated by the virtual image generation optical system 12, and the infrared light retroreflected at the retina R is detected by the infrared light detector 16 incorporated into the image display device 72, thereby detecting and tracking the user's eye gaze.

Meanwhile, a virtual image display device 74 shown in FIG. 9 uses the image display device 68 having a region through which infrared light can be transmitted, similarly to the virtual image display device 64 shown in FIG. 7.

The infrared light source array 14 in which the infrared light sources 14a are arranged is disposed on a side opposite to a visual recognition side (display surface) of the image display device 68. Further, a detector array 76 formed by arranging the infrared light detectors 16 in correspondence with the arrangement of the infrared light sources 14a in the infrared light source array 14 is disposed on an opposite side of the image display device 68 with respect to the infrared light source array 14.

Therefore, in the present example, the infrared light source array 14 also has a region through which infrared light can be transmitted according to the infrared light detector 16 of the detector array 76, similarly to the image display device 68.

Also in the virtual image display device 74, the infrared light sources 14a of the infrared light source array 14 are sequentially turned on while the virtual reality is displayed by the image display device 68, and are collimated by the virtual image generation optical system 12, and the infrared light reflected at the retina R is detected by the infrared light detector 16 of the detector array 76, thereby detecting and tracking the user's eye gaze.

In the virtual image display device of the embodiment of the present invention, the formation density of the infrared light sources 14a is not limited and need only be appropriately set according to the accuracy and the spatial resolution required for the eye gaze detection.

One side of a screen of the image display device provided in the virtual image display device is divided into preferably 10 equal parts or more, more preferably 100 equal parts or more, and still more preferably 1000 equal parts or more, and one infrared light source 14a is provided for each compartment.

In addition, the speed at which the infrared light sources 14a are sequentially turned on is not limited and need only be appropriately set according to the accuracy and the temporal resolution required for the eye gaze detection.

Preferably, all the infrared light sources 14a are sequentially turned on in a time shorter than the time for the image display device to display one frame according to the refresh rate in the image display device provided in the virtual image display device.

Although the eye gaze tracking system and the virtual image display device of the embodiment of the present invention have been described above, the present invention is not limited to the above descriptions, and various improvements and changes may be made without departing from the gist of the present invention, of course.

The eye gaze tracking system and the virtual image display device of the embodiment of the present invention can be suitably used for eye gaze detection in the VR system such as an HMD and an AR system such as an AR glass.

### EXPLANATION OF REFERENCES

12: virtual image generation optical system
14: infrared light source array
14a: infrared light source
16: infrared light detector
62, 68, 72: image display device
24: Fresnel lens
30: quarter-wave plate
32: half mirror
34: reflective polarizer
50: light guide plate
52: light incidence portion
54: light emission portion
64, 70, 74: virtual image display device
E: eye
P: pupil
R: retina

What is claimed is:

1. An eye gaze tracking system comprising:
an infrared light source array;
a virtual image generation optical system; and
an infrared light detector,
wherein infrared light sources of the infrared light source array are sequentially turned on, rays of infrared light are collimated by the virtual image generation optical system, the collimated rays of infrared light are made incident on a user's eye at different angles, respectively, and among the rays of infrared light incident on the eye, a ray of infrared light incident on a retina through a pupil and reflected by the retina is detected by the infrared light detector.

2. A virtual image display device comprising:
the eye gaze tracking system according to claim 1; and
an image display device,
wherein the infrared light source array is incorporated into the image display device.

3. A virtual image display device comprising:
the eye gaze tracking system according to claim 1; and
an image display device,
wherein the image display device includes a region through which infrared light is transmitted, and
the infrared light source array is disposed on a side opposite to a visual recognition side of the image display device.

4. The virtual image display device according to claim 2,
wherein the infrared light detector is incorporated into the image display device.

5. The virtual image display device according to claim 2,
wherein the image display device includes a region through which infrared light is transmitted, and
the infrared light detector is disposed on a side opposite to a visual recognition side of the image display device.

6. The virtual image display device according to claim 2,
wherein the virtual image generation optical system includes at least one of a convex lens or a Fresnel lens.

7. The virtual image display device according to claim 2,
wherein the virtual image generation optical system includes a folded optical system including a reflective polarizer and a half mirror.

8. The virtual image display device according to claim 2,
wherein the virtual image generation optical system includes a light guide plate including a light incidence portion and a light emission portion.

9. The virtual image display device according to claim 8,
wherein at least one of the light incidence portion or the light emission portion includes a diffraction element.

10. The virtual image display device according to claim 9,
wherein the diffraction element is a liquid crystal diffraction element.

11. The virtual image display device according to claim 3,
wherein the infrared light detector is incorporated into the image display device.

12. The virtual image display device according to claim 3,
wherein the image display device includes a region through which infrared light is transmitted, and
the infrared light detector is disposed on a side opposite to a visual recognition side of the image display device.

13. The virtual image display device according to claim 3,
wherein the virtual image generation optical system includes at least one of a convex lens or a Fresnel lens.

14. The virtual image display device according to claim 3,
wherein the virtual image generation optical system includes a folded optical system including a reflective polarizer and a half mirror.

15. The virtual image display device according to claim 3,
wherein the virtual image generation optical system includes a light guide plate including a light incidence portion and a light emission portion.

16. The virtual image display device according to claim 15,
wherein at least one of the light incidence portion or the light emission portion includes a diffraction element.

17. The virtual image display device according to claim 16,
wherein the diffraction element is a liquid crystal diffraction element.

18. The virtual image display device according to claim 3,
wherein the virtual image generation optical system includes at least one of a convex lens or a Fresnel lens.

19. The virtual image display device according to claim 3,
wherein the virtual image generation optical system includes a folded optical system including a reflective polarizer and a half mirror.

20. The virtual image display device according to claim 3,
wherein the virtual image generation optical system includes a light guide plate including a light incidence portion and a light emission portion.
